(19) United States
(12) Patent Application Publication
(10) Pub. No.: US 2013/0016765 A1
(43) Pub. Date: Jan. 17, 2013

(54) SELECTION OF WINDOW LENGTH BASED ON MULTIPLE METRICS

(71) Applicants: Jong Hyeon Park, Santa Clara, CA (US); Brian Clarke Banister, San Diego, CA (US); Zhu Ji, San Diego, CA (US); Gene Fong, San Diego, CA (US); Raghu Narayan Challa, San Diego, CA (US)

(72) Inventors: Jong Hyeon Park, Santa Clara, CA (US); Brian Clarke Banister, San Diego, CA (US); Zhu Ji, San Diego, CA (US); Gene Fong, San Diego, CA (US); Raghu Narayan Challa, San Diego, CA (US)

(73) Assignee: QUALCOMM INCORPORATED, San Diego, CA (US)

(21) Appl. No.: 13/538,817

(22) Filed: Jun. 29, 2012

Related U.S. Application Data
(60) Provisional application No. 61/507,479, filed on Jul. 13, 2011.

(51) Int. Cl. H04L 27/00; H04B 17/00

(52) U.S. Cl. 375/224; 375/295

(57) ABSTRACT

Techniques for windowing a transmission are disclosed herein. In one aspect of the disclosure, the length of a window used for windowing may be configurable and determined for a transmission based on a configuration of the transmission. The configuration of the transmission may be determined based on one or more parameters such as a system bandwidth, a bandwidth assigned for the transmission, the location of the assigned bandwidth within the system bandwidth, a modulation type used for the transmission, etc. In another aspect of the disclosure, a preferred length for a window may be determined for each of a number of possible configurations of a transmission. Different possible window lengths may be evaluated for each possible configuration based on one or more performance metrics. For each configuration, a window length that can provide the best performance for that configuration may be selected as a preferred window length for that configuration.

### CLAIM OF PRIORITY UNDER 35 U.S.C. §119

The present Application for Patent claims the benefit of U.S. Provisional Application Ser. No. 61/507,479, entitled “Method and apparatus for selecting preferred window length based on multiple metrics,” filed Jul. 13, 2011, assigned to the assignee hereof and expressly incorporated herein by reference.

### BACKGROUND

I. Field

The present disclosure relates generally to communication, and more specifically to techniques for performing optimal selection of pulse window length for transmission.

II. Background

Wireless communication systems are widely deployed to provide various communication content such as voice, video, packet data, messaging, broadcast, etc. These systems may be multiple-access systems capable of supporting multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A transmitter (e.g., a base station or a UE) may perform windowing for a transmission prior to sending it via a communication channel. Windowing alters the transmission such that its spectral components and time-domain waveform can provide good performance for the transmission while reducing the amount of interference.

### SUMMARY

Techniques for windowing a transmission are disclosed herein. Windowing is also commonly referred to as pulse shaping, spectral shaping, etc. In one aspect of the present disclosure, the length of a window used for windowing may be configurable and may be determined for a transmission based on a configuration of the transmission. The configuration of the transmission may be determined based on one or more parameters such as a system bandwidth, a bandwidth assigned for the transmission, the location of the assigned bandwidth within the system bandwidth, a modulation type used for the transmission, etc.

In one design, a configuration of a transmission may be determined. A length of a window used for windowing may be determined based on the configuration of the transmission. The determined length may be one of a plurality of possible lengths of the window. At least one transmission symbol for the transmission may be generated based on the window of the determined length and may be sent for the transmission.

In another aspect of the present disclosure, a preferred length of a window used for windowing may be determined for each of a number of possible configurations of a transmission. A set of possible window lengths may be supported by a system. Different possible window lengths may be evaluated for each possible configuration based on one or more performance metrics such as error vector magnitude (EVM), adjacent channel leakage-power ratio (ACLR), in-band emission, spectral emission mask (SEM), etc. For each configuration, the window length that can provide the best performance for that configuration, as quantified by the one or more performance metrics, may be selected as a preferred window length for that configuration. Preferred window lengths for all possible configurations of interest may be stored in a database such as a look-up table.

In one design, at least one list of window lengths for at least one performance metric may be determined, e.g., one list for each performance metric. A window length may be selected for use for windowing from the at least one list of window lengths. The process may be repeated for each of a plurality of possible configurations of a transmission. A plurality of window lengths may be selected for the plurality of possible configurations and may be stored in a database, e.g., a look-up table.

Various aspects and features of the disclosure are described in further detail below.

### BRIEF DESCRIPTION OF THE DRAWINGS

FIG. 1 shows a wireless communication system.

FIG. 2A shows an exemplary frame structure.

FIG. 2B shows an exemplary resource block structure.

FIG. 3 shows different possible resource allocations to a UE.

FIGS. 4A and 4B show block diagrams of a transmit (TX) data processor coupled to an SC-FDMA modulator and an OFDM modulator, respectively.

FIG. 5 illustrates generation of a transmission symbol.

FIG. 6 illustrates overlapping and adding of transmission symbols.

FIG. 7 shows time-domain and frequency-domain representations of a window of different lengths.

FIG. 8 shows a process for determining a preferred window length for each possible transmission configuration.

FIG. 9 shows an example of eight lists of candidate window lengths for eight performance metrics.

FIG. 10 shows an exemplary table of preferred window lengths for different configurations defined by number of assigned resource blocks and starting resource block.

FIG. 11 shows an exemplary table of preferred window lengths for different configurations defined by system bandwidth.

FIG. 12 shows a process for determining preferred window lengths.

FIG. 13 shows a process for sending a transmission with windowing of a configurable length.

FIG. 14 shows an exemplary implementation of an apparatus.

### DETAILED DESCRIPTION

The windowing techniques described herein may be used for various wireless communication systems and standards. The terms “system” and “network” are often used interchangeably. For example, the windowing techniques may be used for CDMA, TDMA, FDMA, OFDMA, SC-FDMA, and other systems. Different systems may implement different radio access technologies. For example, a CDMA system may implement a radio access technology such as Universal Terrestrial Radio Access (UTRA), cdma2000, etc. UTRA includes Wideband CDMA (WCDMA), Low Chip Rate (LCR), and other variants of CDMA. cdma2000 includes IS-2000, IS-95 and IS-856 standards. A TDMA system may implement a radio access technology such as Global System for Mobile Communications (GSM). An OFDMA system may implement a radio access technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA, E-UTRA and GSM are part of Universal Mobile Telecommunication System (UMTS). 3GPP Long Term Evolution (LTE) and LTE-Advanced (LTE-A) are recent releases of UMTS that use E-UTRA. UTRA, E-UTRA, GSM, UMTS, LTE and LTE-A are described in documents from an organization named “3rd Generation Partnership Project” (3GPP). cdma2000 and UMB are described in documents from an organization named “3rd Generation Partnership Project 2” (3GPP2). The techniques described herein may be used for the systems and radio access technologies mentioned above as well as other systems and radio access technologies. For clarity, certain aspects of the techniques are described below for LTE, and LTE terminology is used in much of the description below.

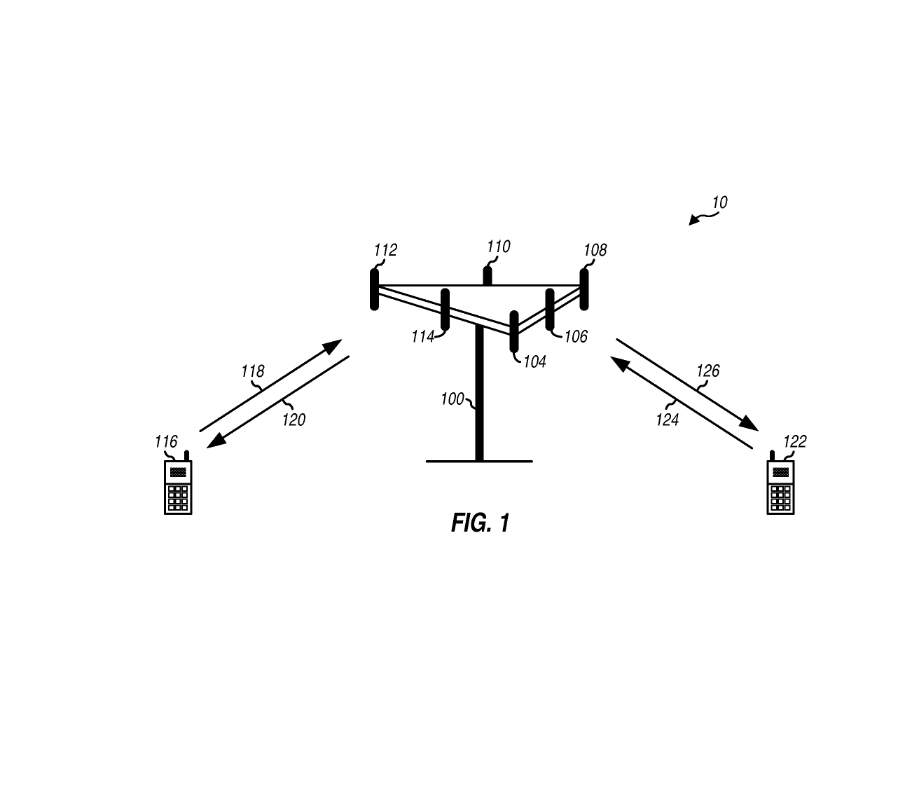

FIG. 1 shows a wireless communication system 10, which may be an LTE system or some other system. System 10 may include evolved Node Bs (eNBs) and other network entities that can support communication for UEs. For simplicity, only one eNB 100 is shown in FIG. 1. eNB 100 may include multiple antenna groups, with one group including antennas 104 and 106, another group including antennas 108 and 110, and an additional group including antennas 112 and 114. In FIG. 1, only two antennas are shown for each antenna group. However, more or fewer antennas may also be utilized for each antenna group. In general, an eNB may be a station used for communicating with the UEs and may also be referred to as a Node B, a base station, an access point, an access node, etc.

In FIG. 1, a UE 116 may be in communication with eNB 100 via antennas 112 and 114, where antennas 112 and 114 transmit information to UE 116 via downlink 120 and receive information from UE 116 via uplink 118. A UE 122 may be in communication with eNB 100 via antennas 104 and 106, where antennas 104 and 106 transmit information to UE 122 via downlink 126 and receive information from UE 122 via uplink 124. In general, a UE may be stationary or mobile and may also be referred to as a mobile station, a terminal, an access terminal, a subscriber unit, a station, etc. A UE may be a cellular phone, a smartphone, a tablet, a wireless communication device, a personal digital assistant (PDA), a wireless modem, a handheld device, a laptop computer, a cordless phone, a wireless local loop (WLL) station, a netbook, a smartbook, etc.

LTE utilizes orthogonal frequency division multiplexing (OFDM) on the downlink and single-carrier frequency division multiplexing (SC-FDM) on the uplink. OFDM and SC-FDM partition a frequency range into multiple (N_{SC}) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (N_{SC}) may be dependent on the system bandwidth. For example, the subcarrier spacing may be 15 kilohertz (KHz), and N_{SC} may be equal to 128, 256, 512, 1024, 1536 or 2048 for system bandwidth of 1.4, 3, 5, 10, 15 or 20 megahertz (MHz), respectively.

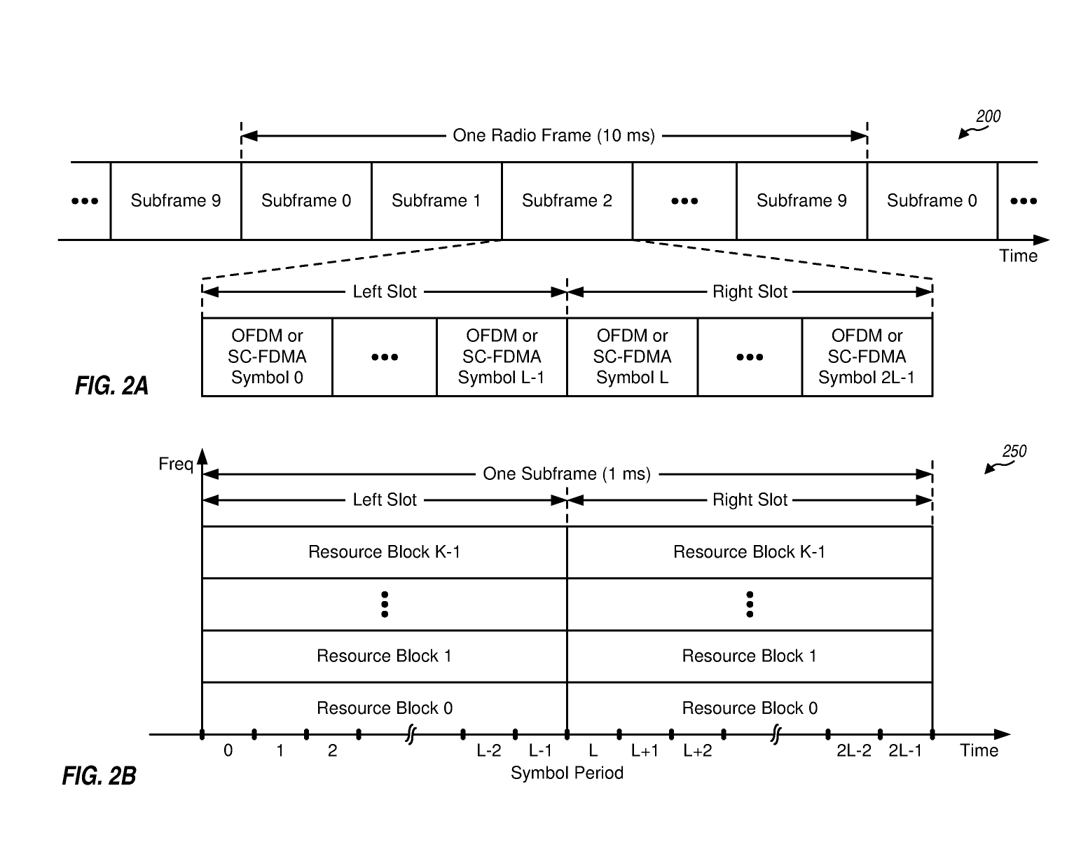

FIG. 2A shows a frame structure 200 in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each slot may include L symbol periods, e.g., seven symbol periods for a normal cyclic prefix or six symbol periods for an extended cyclic prefix. The 2L symbol periods in each subframe may be assigned indices of 0 through 2L−1. On the downlink, an OFDM symbol may be transmitted in each symbol period of a subframe. On the uplink, an SC-FDMA symbol may be transmitted in each symbol period of a subframe.

FIG. 2B shows a resource block structure 250 in LTE. The time frequency resources available for each of the downlink and uplink may be partitioned into units of resource blocks (RBs). Each resource block may cover 12 subcarriers in one slot. The number of resource blocks in each slot (which is denoted as K in FIG. 2B) may be dependent on the system bandwidth and may range from 6 to 110 for system bandwidth of 1.4 to 20 MHz, respectively. Each resource block may include a number of resource elements. Each resource element may cover one subcarrier in one symbol period and may be used to transmit one modulation symbol, which may be a real value or a complex value.

A UE may be assigned one or more resource blocks in a given slot for an uplink transmission to an eNB. The resource block(s) assigned to the UE may be contiguous in frequency in order to maintain a single-carrier waveform and obtain a lower peak-to-average-power ratio (PAPR). The assigned resource block(s) may be indicated by a starting resource block (denoted as startRB) and a number of assigned resource blocks (denoted as allocRB). The terms “assign” and “allocate” may be used interchangeably.

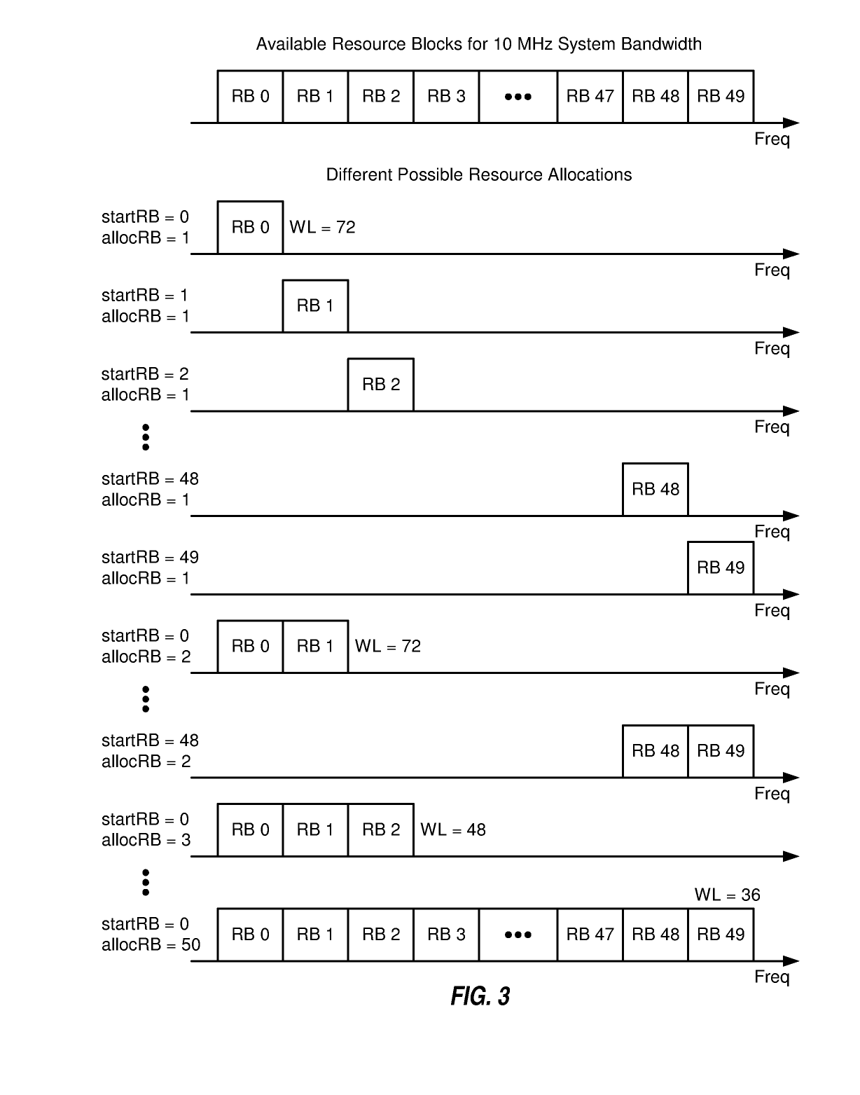

FIG. 3 shows different possible resource allocations to a UE for a system bandwidth of 10 MHz. A total of 50 resource blocks with indices of 0 to 49 may be available for 10 MHz system bandwidth. The UE may be assigned one resource block 0 with startRB=0 and allocRB=1. The UE may be assigned one resource block 1 with startRB=1 and allocRB=1. The UE may be assigned two resource blocks 0 and 1 with startRB=0 and allocRB=2. The UE may be assigned three resource blocks 0 to 2 with startRB=0 and allocRB=3. The UE may be assigned all 50 resource blocks 0 to 49 with startRB=0 and allocRB=50. In general, the UE may be assigned any number of resource blocks at any frequency location via suitable values of startRB and allocRB.

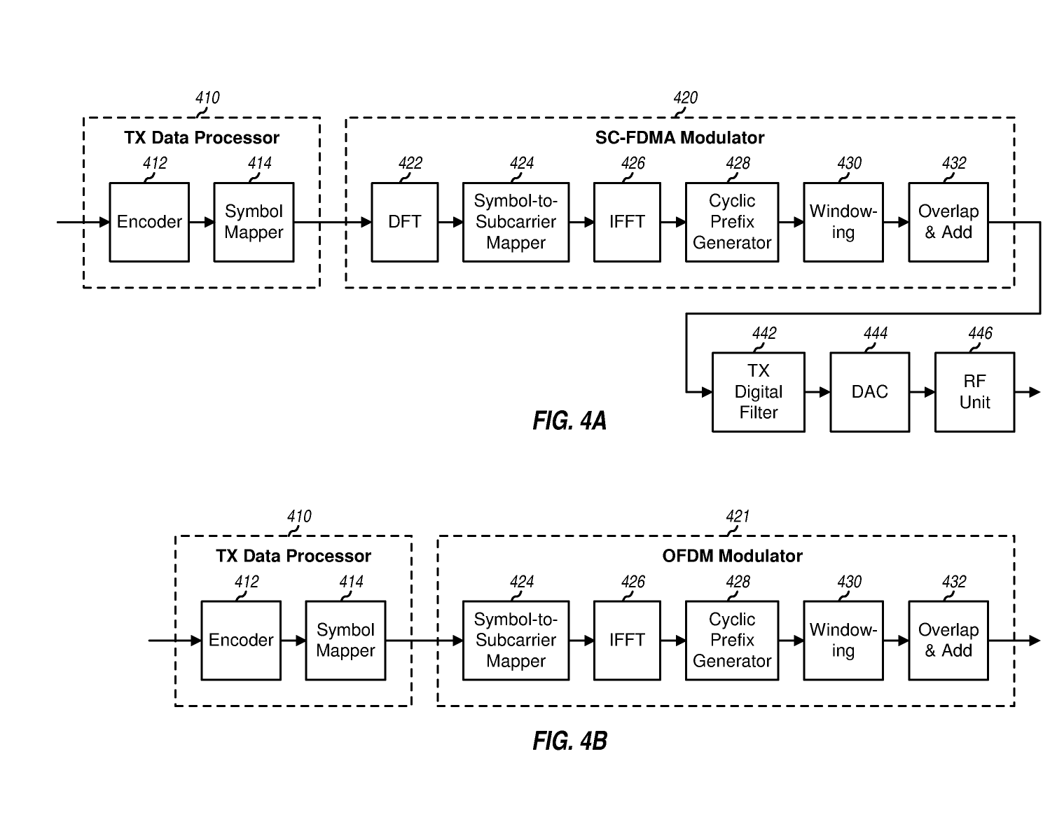

FIG. 4A shows a block diagram of a design of a TX data processor 410 and an SC-FDMA modulator 420, which may be used by a UE to generate SC-FDMA symbols. Within TX data processor 410, an encoder 412 may encode data based on a coding scheme to generate code bits. Encoder 412 may further interleave (or reorder) the code bits based on an interleaving scheme to achieve time and/or frequency diversity. A symbol mapper 414 may map the interleaved bits to modulation symbols based on a modulation type. A modulation type may also be referred to as a modulation order, a modulation scheme, etc. A modulation type may be binary phase shift keying (BPSK), quadrature phase shift keying (QPSK), 16 quadrature amplitude modulation (16-QAM), 64-QAM, etc.

Within SC-FDMA modulator 420, a discrete Fourier transform (DFT) unit 422 may receive N modulation symbols to be sent in one symbol period on N subcarriers of one or more resource blocks assigned to the UE. DFT unit 422 may transform the N modulation symbols to frequency domain with an N-point DFT and provide N frequency-domain symbols. A symbol-to-subcarrier mapper 424 may map the N frequency-domain symbols to the N subcarriers used for transmission, map zero symbols each with a signal value of zero to remaining subcarriers, and provide N_{FFT} symbols. N_{FFT} may be a fixed value (e.g., N_{FFT}=2048), or may be equal to the total number of subcarriers (N_{FFT}=N_{SC}), or may be set to some other value. If N_{FFT}=2048, then mapper 424 may repeat each modulation symbol N_{FFT}/N_{SC} times when N_{FFT}>N_{SC}.

An inverse fast Fourier transform (IFFT) unit 426 may receive N_{FFT} symbols for one symbol period from mapper 424, transform the N_{FFT} symbols to time domain with an N_{FFT}-point IFFT, and provide N_{FFT} time-domain samples for a data/useful portion of an SC-FDMA symbol. A cyclic prefix generator 428 may append a cyclic prefix to the data portion by repeating a part (or N_{CP} samples) of the data portion. The cyclic prefix is used to combat inter-symbol interference (ISI) caused by frequency selective fading, which is a frequency response that varies across the system bandwidth. A windowing unit 430 may receive N_{FFT}+N_{CP} samples for one SC-FDMA symbol from generator 428 and may perform windowing based on a window of a selected length N_{WIN}, as described below. An overlap-and-add unit 432 may receive windowed SC-FDMA symbols for different symbol periods and may add the windowed SC-FDMA symbols to generate output samples for a transmission.

A TX digital filter 442 may filter the output samples from SC-FDMA modulator 420 to limit the transmission to a particular bandwidth. A digital-to-analog converter (DAC) 444 may convert the filtered samples to an analog baseband signal. A radio frequency (RF) unit 446 may process (e.g., filter, amplify, and upconvert) the analog baseband signal to generate an RF signal, which may be transmitted over the air.

FIG. 4B shows a block diagram of a design of TX data processor 410 and an OFDM modulator 421, which may be used by an eNB to generate OFDM symbols in LTE. OFDM modulator 421 includes all units within SC-FDMA modulator 420 in FIG. 4A, except for DFT unit 422. Within OFDM modulator 421, symbol-to-subcarrier mapper 424 may receive N modulation symbols to be sent on N subcarriers in one symbol period, map the N modulation symbols to the N subcarriers used for transmission, map zero symbols to remaining subcarriers, and provide N_{FFT} symbols. The N_{FFT} symbols may be processed by IFFT unit 426, cyclic prefix generator 428, windowing unit 430, and overlap-and-add unit 432 as described above for FIG. 4A.

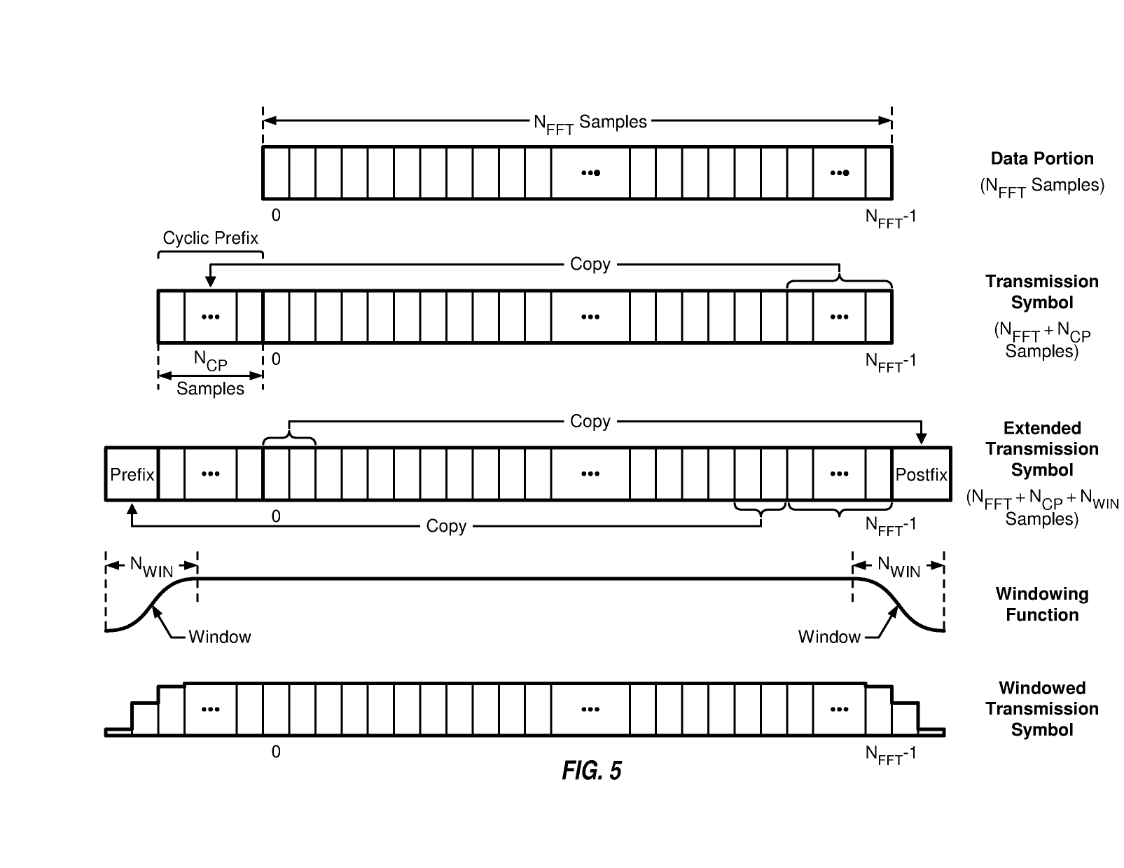

FIG. 5 illustrates generation of a transmission symbol, which may be an OFDM symbol or an SC-FDMA symbol. IFFT unit 426 in FIGS. 4A and 4B may provide N_{FFT} samples for a data portion of the transmission symbol. The last N_{CP} samples of the data portion may be copied and appended to the front of the data portion. The copied samples form a cyclic prefix. A transmission symbol comprises the data portion and the cyclic prefix.

Windowing (which may also be referred to as pulse shaping) may be performed in various manners. In the design shown in FIG. 5, a prefix may be appended to the front of the cyclic prefix by (i) copying N_{PRE} samples of the data portion prior to the N_{CP} samples used for the cyclic prefix and (ii) appending these N_{PRE} samples before the cyclic prefix, as shown in FIG. 5. A postfix may be appended to the end of the data portion by copying the first N_{POST} samples of the data portion and appending these N_{POST} samples after the data portion, as shown in FIG. 5. N_{PRE} and N_{POST} may be selected based on the length N_{WIN} of the window, e.g., N_{WIN}=N_{PRE}+N_{POST}. An extended transmission symbol may include the transmission symbol, the prefix, and the postfix and may thus include N_{FFT}+N_{CP}+N_{WIN} samples. In general, an extended transmission symbol may include only a prefix with a length of N_{WIN}, or only a postfix with a length of N_{WIN}, or both a prefix and a postfix with a combined length of N_{WIN}.

A windowing function of length N_{FFT}+N_{CP}+N_{WIN} may be defined and may include the window on the left side, a reverse of the window on the right side, and a value of 1.0 in the middle. Windowing may be performed by multiplying the N_{FFT}+N_{CP}+N_{WIN} samples of the extended transmission symbol with the N_{FFT}+N_{CP}+N_{WIN} values of the windowing function, element-by-element. The result of windowing is a windowed transmission symbol comprising N_{FFT}+N_{CP}+N_{WIN} samples, with the last N_{WIN} samples on each end gradually tampering off to zero, as shown in FIG. 5.

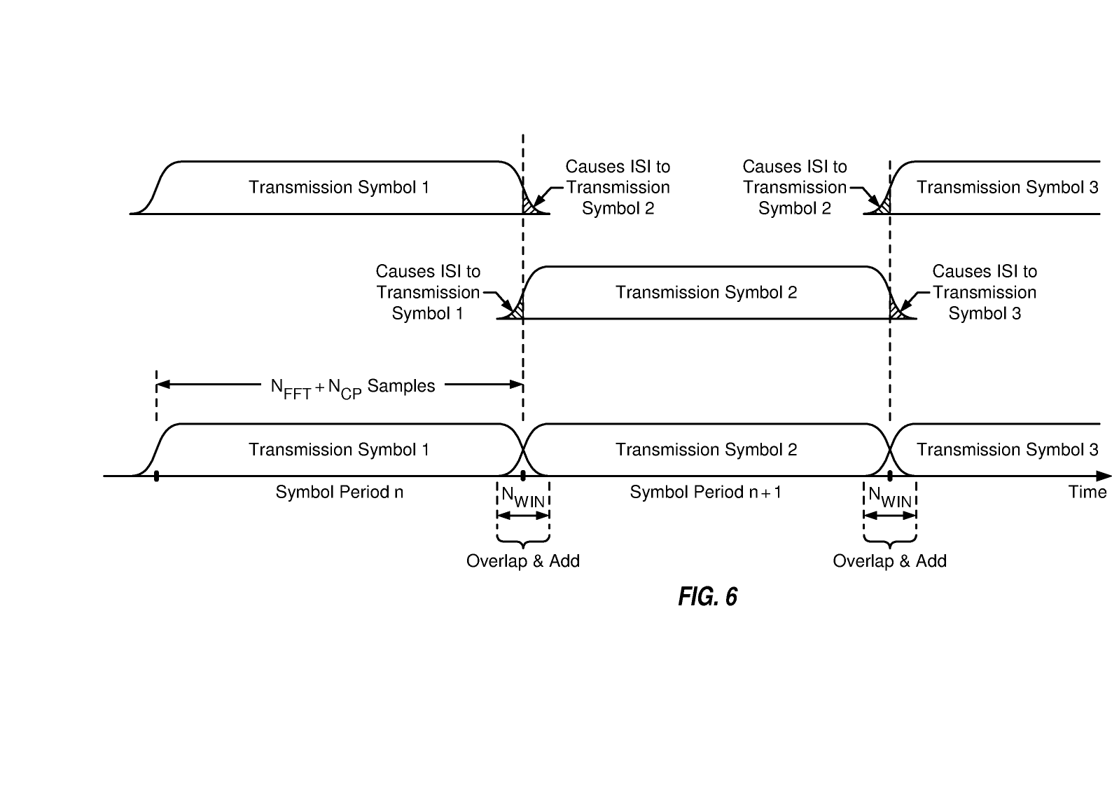

FIG. 6 illustrates overlapping and adding of transmission symbols sent in consecutive symbol periods. A transmission symbol 1 may be generated as described above based on a window of length N_{WIN} and may be sent in symbol period n. A transmission symbol 2 may be generated based on the window of length N_{WIN} and may be sent in the next symbol period n+1. The first and second transmission symbols may be placed such that the last N_{WIN} samples of transmission symbol 1 overlap the first N_{WIN} samples of transmission symbol 2. The overlapped samples may be added. The overlap and add process may be repeated for each subsequent transmission symbol.

As shown in FIG. 6, an extended transmission symbol may include N_{FFT}+N_{CP}+N_{WIN} samples. However, N_{WIN} samples of the extended transmission symbol may overlap with other extended transmission symbols sent in prior and subsequent symbol periods. Hence, the extended transmission symbol may have an effective length of N_{FFT}+N_{CP} samples, which would match the length of a transmission symbol without windowing.

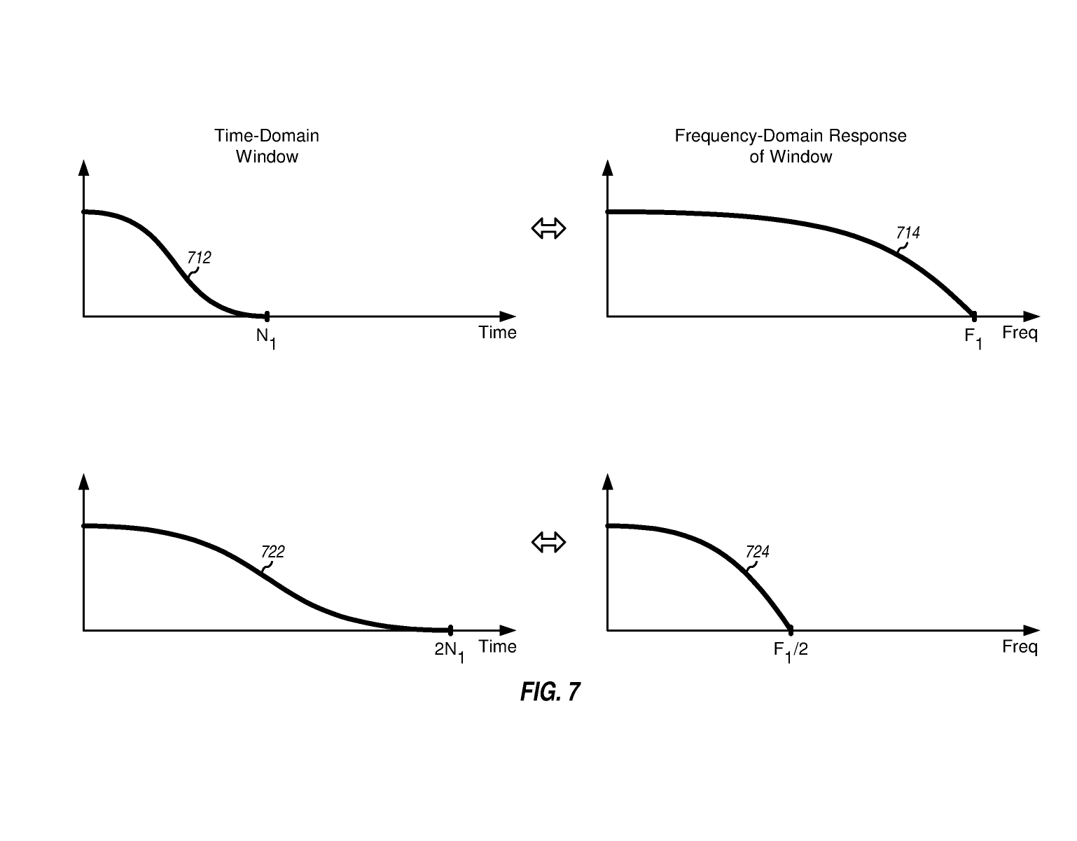

FIG. 7 shows time-domain and frequency-domain representations of a window of different lengths. The window may be defined based on various functions such as a raised-cosine function, a Gaussian function, a Hamming window function, etc. The window may have a length of N₁ in the time domain, as shown by a plot 712 in FIG. 7. A frequency response of the window may be dependent on the particular function used to define the window and may be shown by a plot 714. The window may be extended to double the length of N₁, as shown by a plot 722. A frequency response of the longer window of length 2N₁ in plot 722 may be given by a plot 724 and may have a bandwidth that is half of the bandwidth of the shorter window of length N₁ given by plot 714.

Referring back to FIG. 6, the length of the window may determine the amount of overlap between transmission symbols sent in consecutive symbol periods. A longer window length would result in more overlap and hence more ISI between transmission symbols, which may degrade performance. As shown in FIG. 7, a longer window length may correspond to a smaller bandwidth, which may result in less out-of-band emission. In general, a shorter window length may provide a higher signal-to-noise ratio (SNR) but may be less efficient in suppressing out-of-band emission. Conversely, a longer window length may be more efficient in suppressing out-of-band emission but may introduce more ISI and hence have a lower SNR.

In an aspect of the present disclosure, the length of a window used for windowing may be configurable and may be determined for a transmission based on a configuration of the transmission. The transmission configuration may be determined based on one or more parameters such as the system bandwidth, the bandwidth assigned for the transmission, the location of the assigned bandwidth within the system bandwidth, a modulation type for the transmission, whether filtering is performed for the transmission, etc. The assigned bandwidth may be given by the number of assigned resource blocks (allocRB). The location of the assigned bandwidth may be given by the starting resource block (startRB). The window of the determined length may be used to generate transmission symbols for the transmission.

A number of possible transmission configurations may be defined based on all possible values of one or more parameters for a transmission. A transmission configuration may also be referred to as a configuration, a system configuration, a transmission mode, etc. Each possible transmission configuration may correspond to a specific combination of values for the one or more parameters. For example, two parameters of startRB and alloRB may be used to select a window length. Different possible transmission configurations may be defined based on different possible combinations of values for startRB and alloRB. For example, one transmission configuration may correspond to the case of startRB=0 and alloRB=1, another transmission configuration may correspond to the case of startRB=1 and alloRB=1, etc. Different possible transmission configurations may also be defined in other manners based on other parameters.

In another aspect of the present disclosure, a preferred length of a window used for windowing may be determined for each of a number of possible transmission configurations. A set of possible window lengths may be supported for the window. Different possible window lengths may be evaluated for each possible transmission configuration based on one or more performance metrics such as EVM, ACLR, in-band emission, SEM, etc. For each transmission configuration, the window length that can provide the best performance for that transmission configuration, as quantified by the performance metric(s), may be selected as the preferred window length for that transmission configuration. The preferred window length for each transmission configuration may thus have the best performance among all possible window lengths. The preferred window lengths for all transmission configurations of interest may be stored in a database such as a look-up table. Thereafter, a suitable window length may be selected for use for a particular transmission configuration by accessing the database.

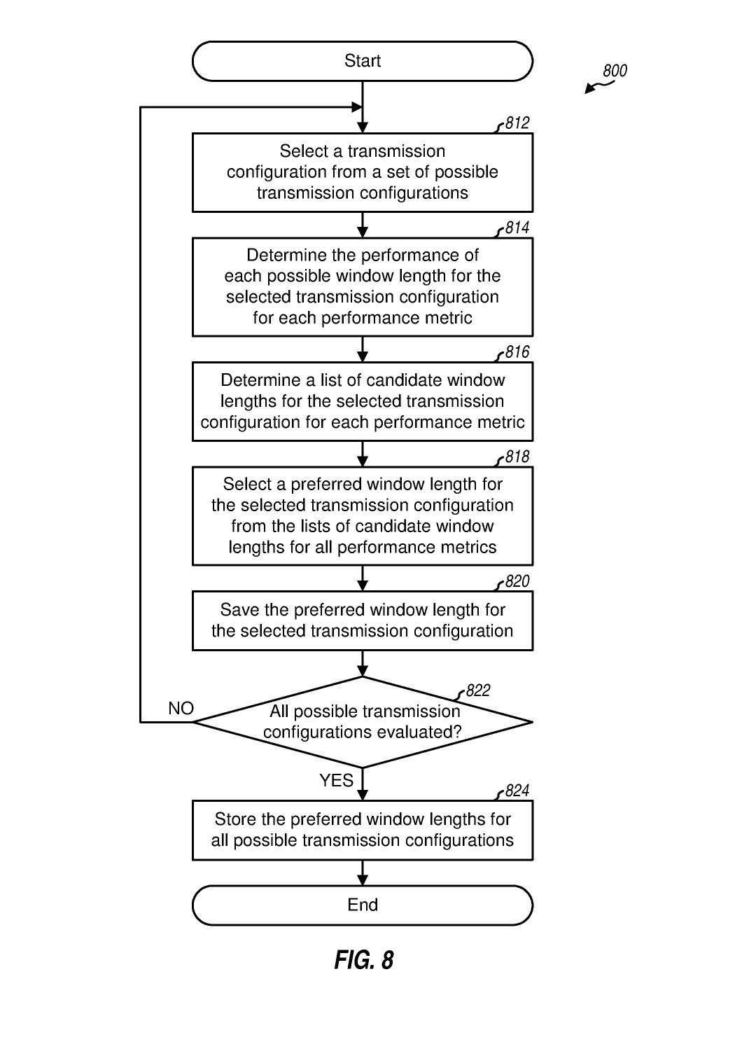

FIG. 8 shows a design of a process 800 for determining a preferred window length for each possible transmission configuration. A transmission configuration may be selected from a set of possible transmission configurations (block 812). A set of performance metrics applicable for the selected transmission configuration may be identified. For example, the set of performance metrics may include EVM, E-UTRA ACLR, UTRA 5 MHz ACLR1, UTRA 5 MHz ACLR2, UTRA 1.6 MHz ACLR1, UTRA 1.6 MHz ACLR2, in-band emission, SEM, etc. EVM is a metric that measures how far received modulation symbols are from ideal constellation points. ACLR is a ratio of transmitted power to measured power after a receive filter in an adjacent RF channel. The performance metrics for LTE are described in 3GPP TS 36.101, which is publicly available. If the same performance metrics are applicable for all possible transmission configurations, then the performance metrics may be identified once. The performance metrics may be assigned different priorities. For example, EVM may have the highest priority, EUTRA ACLR may have the second highest priority, in-band emission may have the third highest priority, etc.

The performance of each possible window length may be determined for the selected transmission configuration for each performance metric (block 814). For example, there may be Q possible window lengths. The performance of each of the Q possible window lengths may be determined for EVM, and also for E-UTRA ACLR, and also for each of the remaining performance metrics. The evaluation may be performed via computer simulation, test measurements, etc. A list of candidate window lengths may be determined for the selected transmission configuration for each performance metric (block 816). The candidate window lengths for each performance metric may include window lengths that can meet the requirements of the performance metric. For example, the performance metric may be EVM, and the requirements of EVM may be X. Each window length for which EVM is better than X may be included in the candidate list for EVM.

A preferred window length may be selected for the transmission configuration from the lists of candidate window lengths for all performance metrics (block 818). The preferred window length may be a candidate window length that is included in all candidate lists and may be the candidate window length associated with the best performance, as quantified by the performance metrics, among the set of possible window lengths. The preferred window length may meet the requirements of all performance metrics for the selected transmission configuration. The preferred window length for the selected transmission configuration may be saved, e.g., in a database such as a look-up table (block 820).

A determination may then be made whether all possible transmission configurations have been evaluated (block 822). If the answer is “No”, then the process may return to block 812 to select another transmission configuration for evaluation. Otherwise, if all transmission configurations have been evaluated and the answer is “Yes” for block 822, then the preferred window lengths for all possible transmission configurations may be stored (block 824). The process may then terminate.

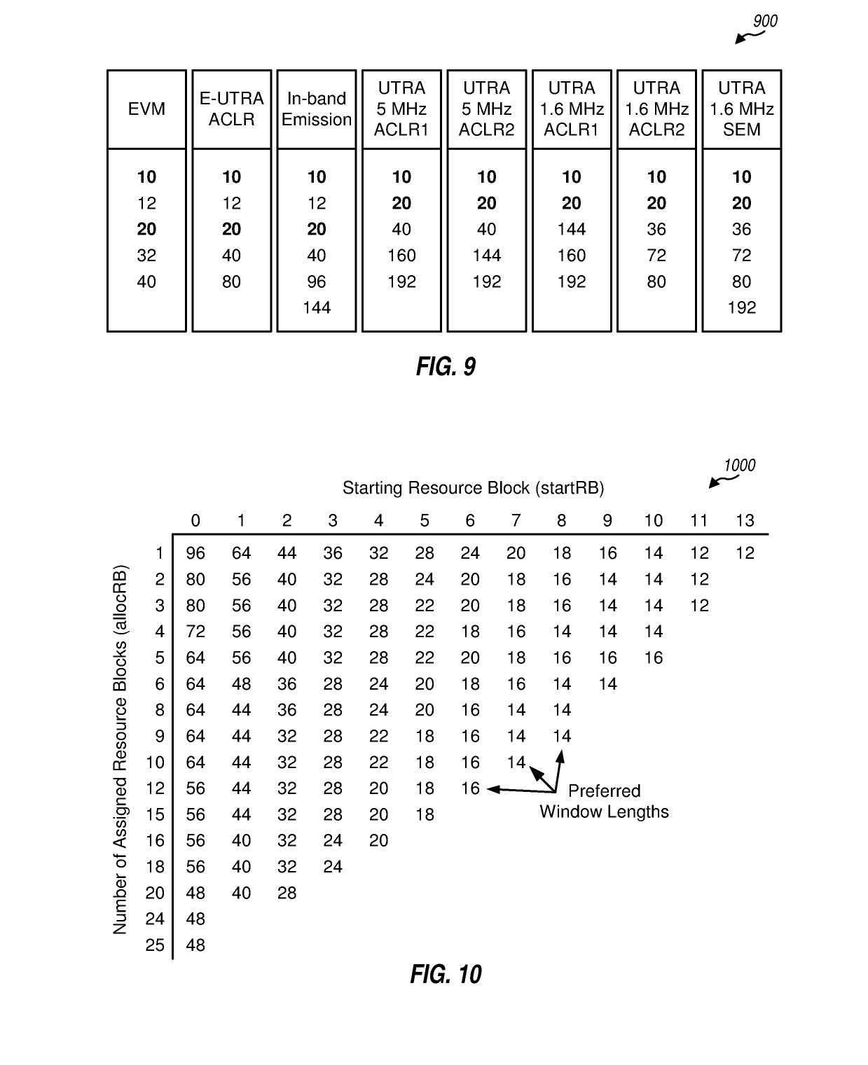

FIG. 9 shows an example of eight lists of candidate window lengths for eight performance metrics for a particular transmission configuration. In one design shown in FIG. 9, a set of possible window lengths may include window lengths of 0, 10, 12, 20, 24, 32, 36, 40, 48, 72, 80, 96, 144, 160 and 192 samples. In other designs, the possible window lengths may include additional, different, or fewer window lengths. The performance of each possible window length was determined for EVM, and window lengths of 10, 12, 20, 32 and 40 samples result in the requirements of EVM being met. The performance of each possible window length was also determined for E-UTRA ACLR, and window lengths of 10, 12, 20, 40 and 80 samples result in the requirements of E-UTRA ACLR being met. The lists of candidate window lengths for the remaining performance metrics are shown in FIG. 9. In the example shown in FIG. 9, window lengths of 10 and 20 samples are included in all eight candidate lists. A preferred window length of 10 or 20 samples may be selected based on their associated performance for the eight performance metrics.

If multiple candidate window lengths appear in all candidate lists (e.g., as shown in FIG. 9), then the preferred window length may be selected from the candidate list for the performance metric with the highest priority. For example, EVM may have the highest priority among all performance metrics. A window length of 10 samples may result in EVM of 1%, and a window length of 20 samples may result in EVM of 2%, with a smaller percentage being better for EVM. In this case, a window length of 10 samples may be selected as the preferred window length. If EVM results are the same or similar for both window lengths of 10 and 20 samples, then the results for EUTRA ACLR having the second highest priority may be considered to select the preferred window length.

If no candidate window length appears in all candidate lists, then in one design the preferred window length may be a candidate window length that is included in the most candidate lists, or in the candidate list for the highest priority performance metric, etc. In another design, one candidate list may be updated. This updating may be performed by (i) choosing a performance metric with the smallest number of window lengths among all candidate lists and (ii) adding one window length from the set of possible window lengths into the candidate list associated with the chosen performance metric. The added window length may not meet the requirements of the performance metric but may come closest to meeting the requirements among all window lengths previously omitted from the candidate list. The search process may then continue and may take into account the updated candidate list. Additional window lengths may be added to one or more candidate lists until at least one window length is included in all candidate lists.

The candidate list for a performance metric may be empty if no window length satisfies the requirements of the performance metric. In this case, the performance metric may be omitted from consideration, and the preferred window length may be selected based on other performance metrics. The preferred window length may also be determined in other manners.

FIG. 10 shows a design of a table 1000 of preferred window lengths for different transmission configurations defined by two parameters for number of assigned resource blocks and starting resource block. The number of assigned resource blocks may be indicative of the bandwidth assigned for a transmission and may be given by allocRB. The starting resource block may be indicative of the location of the assigned bandwidth within the system bandwidth and may be given by startRB. FIG. 10 shows an example in which 25 resource blocks with indices of 0 to 24 are available for a system bandwidth of 5 MHz. For example, a preferred window length of 24 samples may be used for a transmission configuration with startRB=5 and allocRB=2. As another example, a preferred window length of 28 samples may be used for a transmission configuration with startRB=2 and allocRB=20.

Table 1000 stores preferred window lengths for only some of the possible transmission configurations since a resource block allocation is symmetric about the center of the system bandwidth. For example, a preferred window length of 96 samples for a transmission configuration with startRB=0 and allocRB=1 may also be used for a transmission configuration with startRB=24 and allocRB=1. These two transmission configurations are minor of one another about the center of the system bandwidth.

FIG. 3 shows preferred window lengths selected based on two parameters startRB and allocRB for the case of 10 MHz system bandwidth with 50 resource blocks being available for use. For example, a window length (WL) of 72 samples may be used for a transmission configuration with startRB=0 and allocRB=1. Preferred window lengths for other transmission configurations are shown in FIG. 3.

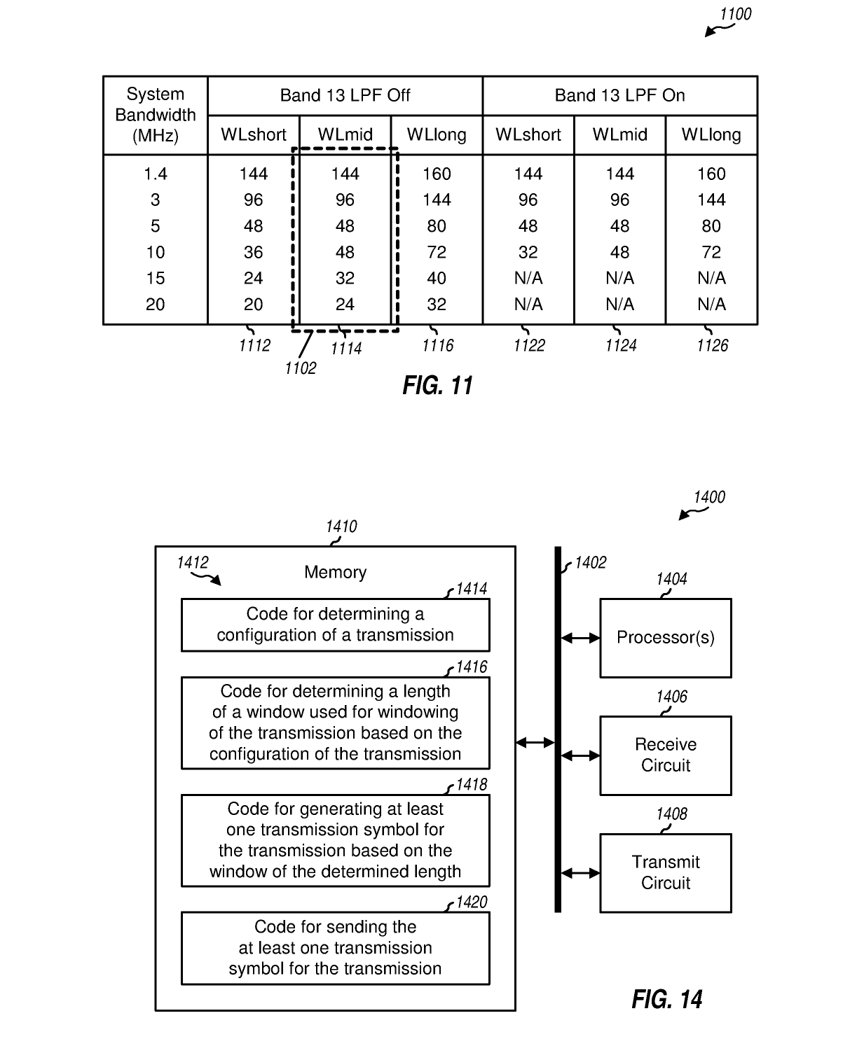

FIG. 11 shows a design of a table 1102 of preferred window lengths for different transmission configurations defined by a parameter for system bandwidth. In one design, medium window lengths (WLmid) in column 1114 may be used for different system bandwidths. As shown in table 1102, progressively longer window length may be used for progressively smaller system bandwidth.

FIG. 11 also shows a design of a table 1100 of preferred window lengths for different transmission configurations defined by three parameters for system bandwidth, resource block allocation, and a lowpass filter (LPF) denoted as Band 13 LPF. Band 13 LPF may be implemented by TX digital filter 442 in FIG. 4A to provide additional filtering for Band 13 in LTE, e.g., to cut off out-of-band signals more sharply. Band 13 LPF may be selectively enabled (i.e., turned “on”) or disabled (i.e., turned “off”) when the system bandwidth is 1.4, 3, 5 or 10 MHz. In one design, medium window lengths (WLmid) in column 1114 may be used when Band 13 LPF is disabled, and the medium window lengths in column 1124 may be used when Band 13 LPF is enabled. Different window lengths may be used for different system bandwidths.

In another design, short window lengths in column 1112 or 1122 may be used when the assigned resource blocks are around the center of the system bandwidth. Medium window lengths in columns 1114 and 1124 may be used when the assigned resource blocks are between the center and an edge of the system bandwidth. Long window lengths in column 1116 or 1126 may be used when the assigned resource blocks are near an edge of the system bandwidth. As shown in table 1100, progressively longer window length may be used for assigned resource blocks located progressively closer to an edge of the system bandwidth in order to provide more rapid attenuation in the frequency domain.

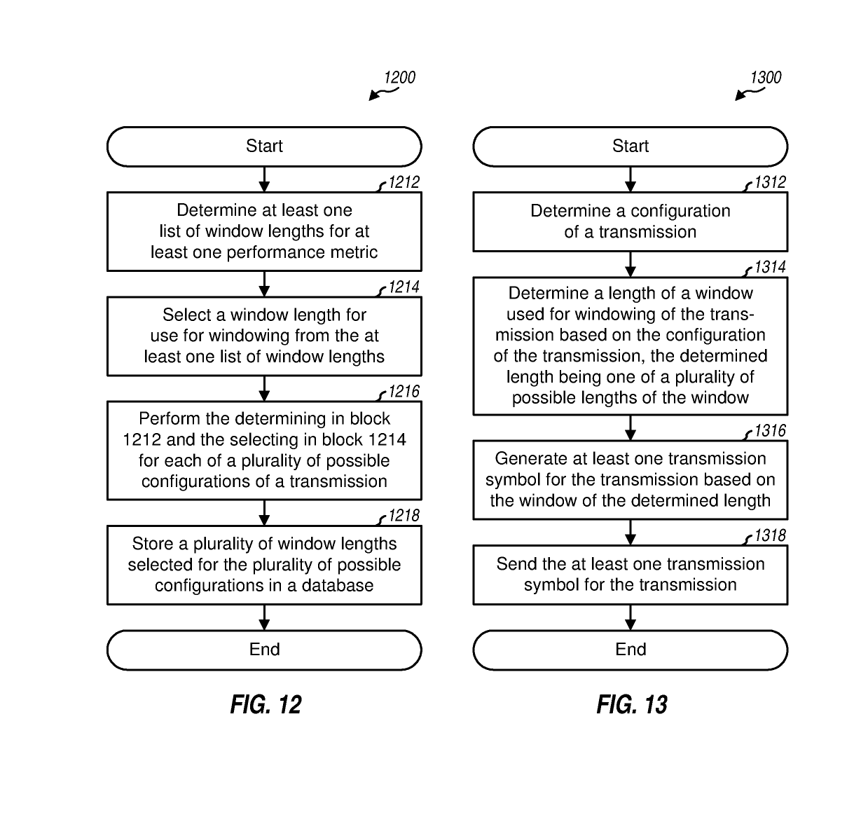

FIG. 12 shows a design of a process 1200 for determining preferred window lengths. Process 1200 may be performed by any entity. At least one list of window lengths for at least one performance metric may be determined (block 1212). The at least one performance metric may include at least one of error vector magnitude, adjacent channel leakage-power ratio, in-band emission, or spectral emission mask. A window length may be selected for use for windowing from the at least one list of window lengths (block 1214).

In block 1212, one list of window lengths may be determined for each of the at least one performance metric. In one design, for each performance metric, the performance of each of a plurality of possible window lengths may be evaluated based on the performance metric. A list of window lengths may be formed for the performance metric based on the performance of each of the plurality of possible window lengths. In one design, the list for each performance metric may include window lengths meeting requirements of the performance metric. In one design, a window length may be added to a list, even when it does not meet performance, if no window length meets the requirements of all performance metrics, as described above. In another design, a performance metric may be removed from consideration if no window length can meet the requirements of that performance metric.

In block 1214, the selected window length may be included in each of the at least one list of window lengths. The window length may also be selected based on a priority of each of the at least one performance metric, or a weight factor assigned to each of the at least one performance metric, or some other information, or any combination thereof.

Blocks 1212 and 1214 may be performed for each of a plurality of possible configurations of a transmission (block 1216). The plurality of possible configurations may be defined based on a plurality of parameters, which may include at least one of a system bandwidth, a bandwidth assigned for a transmission, the location of the assigned bandwidth within the system bandwidth, a modulation type for the transmission, or a state of a filter for the transmission. A plurality of window lengths may be selected for the plurality of possible configurations and may be stored in a database, e.g., a look-up table (block 1218). The database may be indexed or accessed based on the plurality of parameters used to define the plurality of possible configurations.

FIG. 13 shows a design of a process 1300 for sending a transmission with a configurable window length. Process 1300 may be performed by a UE, a base station/eNB, or some other entity. A configuration of a transmission may be determined (block 1312). A length of a window used for windowing may be determined based on the configuration of the transmission (block 1314). The determined length may be one of a plurality of possible lengths of the window. At least one transmission symbol for the transmission may be generated based on the window of the determined length (block 1316). The at least one transmission symbol may comprise at least one OFDM symbol, or at least one SC-FDMA symbol, or at least one symbol of other types. The at least one transmission symbol may be sent for the transmission, which may comprise traffic data, control data, etc. (block 1318).

In one design of block 1312, the configuration of the transmission may be determined based on a number of resource blocks assigned for the transmission (allocRB) and/or a starting resource block assigned for the transmission (startRB). In another design, the configuration of the transmission may be determined based on at least one of a system bandwidth, a bandwidth assigned for the transmission, the location of the assigned bandwidth within the system bandwidth, a modulation type for the transmission, or a state of a filter for the transmission. The configuration of the transmission may also be determined based on other parameters.

In one design of block 1314, a plurality of preferred lengths of the window may be stored for a plurality of possible configurations, e.g., in a database such as a look-up table. A preferred length of the window stored for the configuration of the transmission may be selected for use, e.g., from the database or look-up table. In another design, the plurality of preferred lengths for the plurality of possible configurations may be received from another entity, e.g., from a base station serving a UE.

In one design, a shorter window length may be selected for a larger bandwidth assigned for the transmission, and vice versa, e.g., as shown in FIG. 10. A first length may be selected when the configuration of the transmission is associated with a first bandwidth assigned for the transmission. A second length shorter than the first length may be selected when the configuration of the transmission is associated with a second bandwidth assigned for the transmission, with the second bandwidth being larger than the first bandwidth. In another design, a longer window length may be selected for assigned bandwidth near an edge of the system bandwidth, and vice versa, e.g., as shown in FIG. 10. A first length may be selected when the configuration of the transmission is associated with an assigned bandwidth located around the center of the system bandwidth. A second length longer than the first length may be selected when the configuration of the transmission is associated the assigned bandwidth located away from the center of the system bandwidth. In yet another design, a shorter window length may be selected for a larger system bandwidth, and vice versa, e.g., as shown in FIG. 11. A first length may be selected when the configuration of the transmission is associated with the system bandwidth of a first size. A second length shorter than the first length may be selected when the configuration of the transmission is associated with the system bandwidth of a second size larger than the first size. The length of the window may also be selected in other manners, e.g., based on multiple parameters instead of a single parameter.

In one design of block 1316, windowing may be performed for each of the at least one transmission symbol based on the window of the determined length to obtain a corresponding windowed transmission symbol. Windowed transmission symbols being sent in consecutive symbol periods may be overlapped, e.g., as shown in FIG. 6. Samples of windowed transmission symbols that overlap may be added.

In yet another aspect of the disclosure, one or more characteristics of a window other than window length may be dependent on a configuration of a transmission. In one design, different windowing functions may be used for different transmission configurations. For example, a first windowing function (e.g., a raised-cosine function) may be used for a first set of transmission configurations, a second windowing function (e.g., a Hamming function) may be used for a second set of transmission configurations, etc. In another design, different sets of coefficients for a window may be used for different transmission configurations. Other characteristics of a window may also be dependent on a configuration of a transmission.

FIG. 14 shows part of a hardware implementation of an apparatus 1400, which may be able to perform process 800 in FIG. 8, process 1200 in FIG. 12, and/or process 1300 in FIG. 13. (Please note that FIG. 14 is located after FIG. 11 in the drawings.) Apparatus 1400 includes circuitry and may be one configuration of a user entity (e.g., a UE), a base station/eNB, or some other entity. In this specification and the appended claims, the term “circuitry” is construed as a structural term and not as a functional term. For example, circuitry may be an aggregate of circuit components, such as a multiplicity of integrated circuit components, in the form of processing and/or memory cells, units, blocks and the like, such as shown and described in FIG. 14.

Apparatus 1400 comprises a central data bus 1402 linking several circuits together. The circuits include at least one processor 1404, a receive circuit 1406, a transmit circuit 1408, and a memory 1410. Memory 1410 is in electronic communication with processor(s) 1404, so that processor(s) 1404 may read information from and/or write information to memory 1410. Processor(s) 1404 may comprise a general purpose processor, a central processing unit (CPU), a microprocessor, a digital signal processor (DSP), a controller, a microcontroller, a state machine, an application specific integrated circuit (ASIC), a programmable logic device (PLD), a field programmable gate array (FPGA), etc. Processor(s) 1404 may comprise a combination of processing devices, e.g., a combination of a DSP and a microprocessor, a plurality of microprocessors, one or more microprocessors in conjunction with a DSP core, or any other such configuration.

Receive circuit 1406 and transmit circuit 1408 may be connected to an RF circuit (not shown in FIG. 14). Receive circuit 1406 may process and buffer received signals before sending the signals out to data bus 1402. Transmit circuit 1408 may buffer and process data from data bus 1402 before sending the data out of apparatus 1400. Processor(s) 1404 may perform the function of data management of data bus 1402 and further the function of general data processing, including executing the instructional contents of memory 1410. Transmit circuit 1408 and receive circuit 1406 may be external to processor(s) 1404 (as shown in FIG. 14) or may be part of processor(s) 1404.

Memory 1410 stores a set of instructions 1412 executable by processor(s) 1404 to implement the methods described herein. To implement process 1300 in FIG. 13, instructions 1412 may include code 1414 for determining a configuration of a transmission for apparatus 1400, code 1416 for determining a length of a window used for windowing of the transmission based on the configuration of the transmission, with the determined length being one of a plurality of possible lengths of the window, code 1416 for generating at least one transmission symbol for the transmission based on the window of the determined length, and code 1418 for sending the at least one transmission symbol for the transmission. Instructions 1412 may include other codes for other functions. Memory 1410 may also store a database of preferred window lengths for different possible configurations. Code 1416 may then select a preferred window length for the configuration of the transmission. Alternatively or additionally, memory 1410 may store a set of instructions executable by processor(s) 1404 to implement process 800 in FIG. 8, process 1200 in FIG. 12, and/or other processes for the techniques disclosed herein.

Instructions 1412 shown in memory 1410 may comprise any type of computer-readable statement(s). For example, instructions 1412 in memory 1410 may refer to one or more programs, routines, sub-routines, modules, functions, procedures, data sets, etc. Instructions 1412 may comprise a single computer-readable statement or many computer-readable statements.

Memory 1410 may be a RAM (Random Access Memory) circuit. Memory 1410 may be tied to another memory circuit (not shown), which may either be of a volatile or a nonvolatile type. As an alternative, memory 1410 may be made of other circuit types, such as an EEPROM (Electrically Erasable Programmable Read Only Memory), an EPROM (Electrical Programmable Read Only Memory), a ROM (Read Only Memory), an ASIC (Application Specific Integrated Circuit), a magnetic disk, an optical disk, and others well known in the art. Memory 1410 may be considered to be an example of a computer-program product that comprises a computer-readable medium with instructions 1412 stored therein.

The previous description of the disclosure is presented to enable any person skilled in the art to make and use the disclosure. Details are set forth in the previous description for purpose of explanation. It should be appreciated that one of ordinary skill in the art would realize that the disclosure may be practiced without the use of these specific details. In other instances, well-known structures and processes are not elaborated in order not to obscure the description of the disclosure with unnecessary details. Thus, the present invention is not intended to be limited by the examples and designs described herein, but is to be accorded with the widest scope consistent with the principles and features disclosed herein.

The functions described herein may be implemented in hardware, software, firmware, or any combination thereof. If implemented in software, the functions may be stored as one or more instructions on a computer-readable medium. The term “computer-readable medium” or “computer program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the networks, methods, and apparatus described herein without departing from the scope of the claims.

No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for communication, comprising:
determining a configuration of a transmission;
determining a length of a window used for windowing of the transmission based on the configuration of the transmission, the determined length being one of a plurality of possible lengths of the window; and
generating at least one transmission symbol for the transmission based on the window of the determined length.

2. The method of claim 1, wherein the determining the configuration of the transmission comprises determining the configuration of the transmission based on a number of resource blocks assigned for the transmission, or a starting resource block assigned for the transmission, or both.

3. The method of claim 1, wherein the determining the configuration of the transmission comprises determining the configuration of the transmission based on at least one of a system bandwidth, a bandwidth assigned for the transmission, location of the assigned bandwidth within the system bandwidth, a modulation type for the transmission, or a state of a filter for the transmission.

4. The method of claim 1, wherein the selecting the length of the window comprises
selecting a first length when the configuration of the transmission is associated with a first bandwidth assigned for the transmission, and
selecting a second length shorter than the first length when the configuration of the transmission is associated with a second bandwidth larger than the first bandwidth.

5. The method of claim 1, wherein the selecting the length of the window comprises
selecting a first length when the configuration of the transmission is associated with an assigned bandwidth located around a center of a system bandwidth, and
selecting a second length longer than the first length when the configuration of the transmission is associated the assigned bandwidth located away from the center of the system bandwidth.

6. The method of claim 1, wherein the selecting the length of the window comprises
selecting a first length when the configuration of the transmission is associated with a system bandwidth of a first size, and
selecting a second length shorter than the first length when the configuration of the transmission is associated with the system bandwidth of a second size larger than the first size.

7. The method of claim 1, further comprising:
storing a plurality of preferred lengths of the window for a plurality of possible configurations, and wherein the selecting the length of the window comprises selecting a preferred length of the window stored for the configuration of the transmission.

8. The method of claim 1, wherein the generating at least one transmission symbol comprises
windowing each of the at least one transmission symbol based on the window of the determined length to obtain a corresponding windowed transmission symbol,
overlapping windowed transmission symbols being sent in consecutive symbol periods, and
adding samples of windowed transmission symbols that overlap.

9. The method of claim 1, wherein the at least one transmission symbol comprises at least one orthogonal frequency division multiplex symbol.

10. The method of claim 1, wherein the at least one transmission symbol comprises at least one single-carrier frequency division multiple access symbol.

11. An apparatus for communication, comprising:
means for determining a configuration of a transmission;
means for determining a length of a window used for windowing of the transmission based on the configuration of the transmission, the determined length being one of a plurality of possible lengths of the window; and
means for generating at least one transmission symbol for the transmission based on the window of the determined length.

12. The apparatus of claim 11, wherein the means for determining the configuration of the transmission comprises means for determining the configuration of the transmission based on a number of resource blocks assigned for the transmission, or a starting resource block assigned for the transmission, or both.

13. The apparatus of claim 11, wherein the means for determining the configuration of the transmission comprises means for determining the configuration of the transmission based on at least one of a system bandwidth, a bandwidth assigned for the transmission, location of the assigned bandwidth within the system bandwidth, a modulation type for the transmission, or a state of a filter for the transmission.

14. The apparatus of claim 11, wherein the means for selecting the length of the window comprises
means for selecting a first length when the configuration of the transmission is associated with a first bandwidth assigned for the transmission, and
means for selecting a second length shorter than the first length when the configuration of the transmission is associated with a second bandwidth larger than the first bandwidth.

15. The apparatus of claim 11, wherein the means for selecting the length of the window comprises
means for selecting a first length when the configuration of the transmission is associated with an assigned bandwidth located around a center of a system bandwidth or is associated with a system bandwidth of a first size, and
means for selecting a second length longer than the first length when the configuration of the transmission is associated the assigned bandwidth located away from the center of the system bandwidth.

16. The apparatus of claim 11, wherein the means for selecting the length of the window comprises
means for selecting a first length when the configuration of the transmission is associated with a system bandwidth of a first size, and
means for selecting a second length shorter than the first length when the configuration of the transmission is associated with the system bandwidth of a second size larger than the first size.

17. An apparatus for communication, comprising:
circuitry configured to:
determine a configuration of a transmission;
determine a length of a window used for windowing of the transmission based on the configuration of the transmission, the determined length being one of a plurality of possible lengths of the window; and
generate at least one transmission symbol for the transmission based on the window of the determined length.

18. The apparatus of claim 17, wherein the circuitry is configured to:
determine the configuration of the transmission based on a number of resource blocks assigned for the transmission, or a starting resource block assigned for the transmission, or both.

19. The apparatus of claim 17, wherein the circuitry is configured to:
determine the configuration of the transmission based on at least one of a system bandwidth, a bandwidth assigned for the transmission, location of the assigned bandwidth within the system bandwidth, a modulation type for the transmission, or a state of a filter for the transmission.

20. The apparatus of claim 17, wherein the circuitry is configured to:
select a first length when the configuration of the transmission is associated with a first bandwidth assigned for the transmission, and
select a second length shorter than the first length when the configuration of the transmission is associated with a second bandwidth larger than the first bandwidth.

21. The apparatus of claim 17, wherein the circuitry is configured to:
select a first length when the configuration of the transmission is associated with an assigned bandwidth located around a center of a system bandwidth, and
select a second length longer than the first length when the configuration of the transmission is associated the assigned bandwidth located away from the center of the system bandwidth.

22. The apparatus of claim 17, wherein the circuitry is configured to:
select a first length when the configuration of the transmission is associated with a system bandwidth of a first size, and
select a second length shorter than the first length when the configuration of the transmission is associated with the system bandwidth of a second size larger than the first size.

23. A computer program product, comprising:
a non-transitory computer-readable medium comprising:
code for causing at least one computer to determine a configuration of a transmission;
code for causing the at least one computer to determine a length of a window used for windowing of the transmission based on the configuration of the transmission, the determined length being one of a plurality of possible lengths of the window; and
code for causing the at least one computer to generate at least one transmission symbol for the transmission based on the window of the determined length.

24. A method for communication, comprising:
determining at least one list of window lengths for at least one performance metric; and
selecting a window length to use for windowing from the at least one list of window lengths.

25. The method of claim 24, wherein the determining the at least one list of window lengths for at least one performance metric comprises
for each performance metric,
evaluating performance of each of a plurality of possible window lengths based on the performance metric, and
forming a list of window lengths for the performance metric based on the performance of each of the plurality of possible window lengths.

26. The method of claim 24, wherein the at least one list of window lengths includes one list for each performance metric, and wherein the list for each performance metric includes window lengths meeting requirements of the performance metric.

27. The method of claim 24, wherein the selected window length is included in each of the at least one list of window lengths.

28. The method of claim 24, wherein the at least one performance metric includes at least one of error vector magnitude, adjacent channel leakage-power ratio, in-band emission, or spectral emission mask.

29. The method of claim 24, wherein the selecting the window length comprises selecting the window length based on a priority of each of the at least one performance metric.

30. The method of claim 24, wherein the selecting the window length comprises selecting the window length based on a weight factor assigned to each of the at least one performance metric.

31. The method of claim 24, further comprising:
performing the determining at least one list of window lengths and the selecting a window length for each of a plurality of possible configurations of a transmission.

32. The method of claim 31, wherein the plurality of possible configurations are defined based on at least one of a system bandwidth, a bandwidth assigned for a transmission, location of the assigned bandwidth within the system bandwidth, a modulation type for the transmission, or a state of a filter for the transmission.

33. The method of claim 31, further comprising:
storing a plurality of window lengths selected for the plurality of possible configurations in a database.

34. An apparatus for communication, comprising:
means for determining at least one list of window lengths for at least one performance metric; and
means for selecting a window length to use for windowing from the at least one list of window lengths.

35. The apparatus of claim 34, wherein the means for determining the at least one list of window lengths for at least one performance metric comprises
for each performance metric,
means for evaluating performance of each of a plurality of possible window lengths based on the performance metric, and
means for forming a list of window lengths for the performance metric based on the performance of each of the plurality of possible window lengths.

36. The apparatus of claim 34, wherein the at least one performance metric includes at least one of error vector magnitude, adjacent channel leakage-power ratio, in-band emission, or spectral emission mask.

37. The apparatus of claim 34, further comprising:
means for determining at least one list of window lengths and selecting a window length for each of a plurality of possible configurations of a transmission, the plurality of possible configurations being defined based on at least one of a system bandwidth, a bandwidth assigned for a transmission, location of the assigned bandwidth within the system bandwidth, a modulation type for the transmission, or a state of a filter for the transmission.

38. An apparatus for communication, comprising:
circuitry configured to:
determine at least one list of window lengths for at least one performance metric; and
select a window length to use for windowing from the at least one list of window lengths.

39. The apparatus of claim 38, wherein the circuitry is configured to:
for each performance metric,
evaluate performance of each of a plurality of possible window lengths based on the performance metric, and
form a list of window lengths for the performance metric based on the performance of each of the plurality of possible window lengths.

40. The apparatus of claim 38, wherein the at least one performance metric includes at least one of error vector magnitude, adjacent channel leakage-power ratio, in-band emission, or spectral emission mask.

41. The apparatus of claim 38, wherein the circuitry is configured to determine at least one list of window lengths and select a window length for each of a plurality of possible configurations of a transmission, the plurality of possible configurations being defined based on at least one of a system bandwidth, a bandwidth assigned for a transmission, location of the assigned bandwidth within the system bandwidth, a modulation type for the transmission, or a state of a filter for the transmission.

42. A computer program product, comprising:
a non-transitory computer-readable medium comprising:
code for causing at least one computer to determine at least one list of window lengths for at least one performance metric; and
code for causing the at least one computer to select a window length to use for windowing from the at least one list of window lengths.
